(19) United States
(12) Patent Application Publication
(10) Pub. No.: US 2017/0016276 A1
(43) Pub. Date: Jan. 19, 2017

(54) Foldable Platform Step Ladder

(71) Applicant: Ronald F. Seiler, North Fort Myers, FL (US)

(72) Inventor: Ronald F. Seiler, North Fort Myers, FL (US)

(21) Appl. No.: 14/803,053

(22) Filed: Jul. 18, 2015

(51) Int. Cl. E06C 1/387; E06C 7/00

(52) U.S. Cl. CPC E06C 1/387; E06C 7/00

(57) ABSTRACT

The present invention comprises a foldable platform step ladder having one or more railing sides which are pivotable along a first pivot axis, a first hinge which facilitates the railing sides pivoting along the first pivot axis, a platform step which is pivotable along a second pivot axis; and a second hinge which facilitates the platform step pivoting along the second pivot axis. When the railing sides or the platform step are in a use position, one of the first hinge or the second hinge are in a locked position. When the railing sides or the platform step are in a non-use position, one of the first hinge or the second hinge are in an open position allowing pivoting motion along the first pivot axis and the second pivot axis.

### FIELD OF THE INVENTION

The present invention relates to a platform step ladder with foldable platform steps and a folding railing and frame.

### BACKGROUND OF THE INVENTION

Ladders are ancient tools and technology. A ladder is depicted in a Mesolithic rock painting that is at least 10,000 years old, depicted in the Spider Caves in Valencia, Spain. The painting depicts two humans using a ladder to reach a wild honeybee nest to harvest honey. The ladder is depicted as long and flexible, possibly made out of some kind of grass.

Ladder functionality, design and construction have drastically changed since this original ladder depiction, highly dependent upon the use and need for the ladder. A number which have similar shapes and designs to a stair case or a set of stairs as compared to more traditional folding ladder construction of narrow slats are difficult to move and use, except in large open and often commercial setting, such as a warehouse or box store.

The present invention relates to a design which incorporates the ease of use of a traditionally commercial rolling ladder with the necessity for small storage size and shape for home use and/or use by individuals with physical limitations.

### SUMMARY OF THE INVENTION

It is, therefore, an object of the present invention to provide a foldable platform step ladder, which can be used in any environment where a ladder which allows a user to walk up the ladder as compared to climbing the ladder is functionally necessary, including but not limited, an environment where additional stability is required, where a user has a physical limitation or any other reasonable environment for a step ladder is commonly used.

One exemplary embodiment of the present invention includes a foldable platform step ladder comprised of one or more railing sides, at least one first hinge, at least one platform step, and at least one second hinge.

In one exemplary aspect of the present embodiment, the one or more railing sides can be pivotable along a first pivot axis.

In another exemplary aspect of the present embodiment, the at least one first hinge can facilitate the one or more railing sides pivoting along the first pivot axis.

In yet another exemplary aspect of the present embodiment, the at least one platform step can be pivotable along a second pivot axis.

In yet another exemplary aspect of the present embodiment, the at least one second hinge can facilitate the at least one platform step pivoting along the second pivot axis.

In yet still another exemplary aspect of the present embodiment, when the one or more railing sides or the at least one platform step are in a use position, one of the at least one first hinge or the at least one second hinge can be in a locked position.

In a further exemplary aspect of the present embodiment, when the one or more railing sides or the at least one platform step are in a non-use position, one of the at least one first hinge or the at least one second hinge can be in an open position allowing pivoting motion along the first pivot axis and the second pivot axis.

The following are additional and/or exemplary aspects of the present embodiment, one or more of which can be combined with the basic invention as embodied above:
when the one or more railing sides and the at least one platform step are in a use position, the at least one first hinge and the at least one second hinge can be in a locked position;
when the one or more railing sides and the at least one platform step are in a non-use position, the at least one first hinge and the at least one second hinge can be in an open position allowing pivoting motion along the first pivot axis and the second pivot axis;
the one or more railing sides can be pivotable along the first pivot axis independently from the at least one platform and the one or more railing sides can be pivotable along the first pivot axis independently from one another;
the one or more railing sides can be pivotable along the first pivot axis in a range from 0° to 360° via the at least one first hinge;
at least one support arm can connect the one or more railing sides which can be pivotable along the first pivot axis via the at least one first hinge;
the one or more railing sides can be pivotable along the first pivot axis independently from each other;
the at least one platform step can be pivotable along the second pivot axis in a range from 0° to 180°;
the at least one platform step can be removable; and
each element of the foldable platform ladder can be manufactured from any combination of metals, metallic composites, plastics and plastic composites.

Another exemplary embodiment of the present invention includes a foldable platform ladder comprising at least one first railing side, at least one first hinge, at least one second railing side, at least one second hinge, at least one platform step, and at least one third hinge.

In one exemplary aspect of the present embodiment, the at least one first railing side can be pivotable along a first pivot axis.

In another exemplary aspect of the present embodiment, the at least one first hinge can facilitate the at least one first railing side pivoting along the first pivot axis.

In another exemplary aspect of the present embodiment, the at least one second railing side can be pivotable along a first pivot axis.

In a further exemplary aspect of the present embodiment, the at least one second hinge can facilitate the at least one second railing side pivoting along the first pivot axis.

In yet still another exemplary aspect of the present embodiment, the at least one platform step can be pivotable along a second pivot axis.

In yet still a further exemplary aspect of the present embodiment, the at least one third hinge can facilitate the at least one platform step pivoting along the second pivot axis.

In still another exemplary aspect of the present embodiment, when the at least one first railing side, the at least one second railing side and the at least one platform step are in an use position, one of the at least one first hinge, the at least one second hinge and the at least one third hinge can be in a locked position.

In yet still a further exemplary aspect of the present embodiment, when the at least one first railing side, the at least one second railing side and the at least one platform step are in a non-use position, one of the at least one first hinge, the at least one second hinge, and the at least one third hinge are in an open position allowing pivoting motion along the first pivot axis and the second pivot axis.

The following are additional and/or exemplary aspects of the present embodiment, one or more of which can be combined with the basic invention as embodied above:
at least one second platform step which can be pivotable along a third pivot axis via the at least one third hinge;
the at least one first railing side and the at least one second railing side can be pivotable along the first pivot axis independently from the at least one first platform step and can be pivotable along the first pivot axis independently from one another;
the at least one first platform step and the at least one second platform step can be pivotable along the third pivot axis independently from one another;
the at least one first railing side and the at least one second railing side can be pivotable along the first pivot axis in a range from 0° to 360° via the at least one first hinge;
the at least one first platform and the at least one second platform can be pivotable along the third pivot axis in a range from 0° to 180°;
the at least one platform step can be removable;
the at least one second platform step can be removable; and
at least one support arm can connect the at least one first railing side and the at least second railing, wherein the support arm can pivot along the first pivot axis via at least one fifth hinge.

One exemplary method of employing a foldable platform step ladder to a use position, as described in the exemplary embodiment above, can comprise the following steps:
rotating one or more railing sides to a use position by pivoting said one or more railing sides via at least one first hinge along a first pivot axis and locking the at least one first hinge; and
rotating one or more platform steps to a use position by pivoting said one or more platform steps via at least one second hinge along a second pivot axis and locking the at least one second hinge.

The following are additional and/or exemplary aspects of the present method embodiment, one or more of which can be combined with the basic invention as embodied above:
rotating the one or more platform steps to a non-use position by unlocking the at least one second hinge and pivoting said one or more platform steps along the second pivot axis; and
rotating the one or more railing sides to a non-use position by unlocking the first hinge and pivoting said at least first railing side along the first pivot axis.

These and other exemplary aspects of the present invention are described herein.

Those skilled in the art will recognize still other aspects of the present invention upon reading and understanding the attached description.

### BRIEF DESCRIPTION OF THE DRAWINGS

The present invention is illustrated by way of example, and not in limitation, in the figures of the accompanying drawings.

FIG. 1 illustrates an exemplary embodiment of the present invention, including a folding platform ladder which has side railings and platform steps in a use position.

FIG. 2 illustrates an exemplary embodiment of the present invention, including a folding platform ladder which has side railings in a use position and showing one platform step in a folding or closing motion position.

FIG. 3 illustrates an exemplary embodiment of the present invention, including a folding platform ladder which has side railings in a use position and platform steps in a non-use or closed position.

FIG. 4 illustrates an additional exemplary embodiment of the present invention, including a foldable platform ladder which has side railings and platform steps in a non-use or closed position.

FIG. 5 illustrates an exemplary method of employing a foldable platform ladder according to the inventive concept.

### DETAILED DESCRIPTION OF THE INVENTION

The present invention will now be described more fully herein after with reference to the accompanying drawings, which form a part hereof, and which show, by way of illustration, specific exemplary embodiments by which the invention may be practiced. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. Among other things, the present invention may be embodied as methods or devices. Accordingly, various exemplary embodiments may take the form of an entirely hardware embodiments, an entirely software embodiment and/or an embodiment combining software and hardware aspects. The following detailed description is, therefore, not to be taken in a limiting sense.

Throughout the specification and claims, the following terms take the meanings explicitly associated herein, unless the context clearly otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope. its purpose is merely to present some concepts in a simplified form as a prelude to the more detailed description that is presented later.

The present invention generally relates to a foldable platform ladder which has wide platform steps situated in a staircase fashion with side railings to allow a user to walk up the platform steps using the railing sides as support instead of climbing a ladder as is common in a traditional step ladder configuration. The platform steps are foldable along a pivot axis, up to 180°, and are also optionally removable. Railing sides are additionally foldable along a pivot axis, up to 360°, such that the foldable platform ladder can change size and shape dramatically to be storable in a small and/or narrow space.

FIG. 1 illustrates one exemplary embodiment of foldable platform step ladder 100 which includes one or more railing sides 110, at least one first hinge 120, at least one platform step 130 and at least one second hinge 140.

Railing sides 110 can pivot along a first pivot axis 170. Railing sides 110, as illustrated, provide the structural support element for foldable platform step ladder 100. It is contemplated that railing sides 110 provide a balance element for a user of ladder 100.

Railing sides 110 are illustrated in FIG. 1 as having a generally parallelogram shape, however other shapes are contemplated, by way of example only, hexagonal, triangular, octagonal, circular, or any other functionally necessary and/or compatible shape which provides a rigid, weight-bearing shape or frame which can also provide easily accessible locations for a user to place a hand or other lifting or moving apparatus. It is further contemplated that railing sides 110 have the same, similar or different shapes, as functionally necessary to operate ladder 100.

First hinge 120 can facilitate railing sides 110 pivoting along first pivot axis 170. First hinge 120 can be any type of bearing that connects two solid objects which also allows those objects to rotate relative to each other about first pivot axis 170, which is illustrated as a fixed axis of rotation. First hinge 120 may be constructed of a flexible material and/or of a combination of static and/or moving components.

As illustrated in FIG. 1, first hinge 120 is contemplated to be a barrel hinge, which can be a sectional barrel secured by a turnable pin or axle, where the rotational bearing force is applied to the pin or axle. However, in additional embodiments of the present invention, additional hinge configurations are also contemplated, including but not limited to pivot hinges, mortise hinges, case hinges, piano hinges, butterfly hinges, or any other functionally necessary and/or compatible hinge type.

Railing sides 110 are pivotable along first pivot axis 170 in a range from 0° to 360° via first hinge 120. This range is functionally necessary to insure that ladder 100 can easily change size and shape to be storable in a small and/or narrow space.

Additional embodiments further contemplate that railing sides 110 can be pivotable along first pivot axis 170 independently from one another.

As also illustrated in FIG. 1, support arm 114 can connect railing sides 110 and can also be pivotable along first pivot axis 170 via the at least one first hinge 120. Support arm 114 provides additional structural support by providing a brace point for railing sides 110. Support arm 114 is illustrated in FIG. 1 as a linear component, however, in additional embodiments support arm 114 is contemplated to have any desired shape which can also provide the support function, for example, a curved or arced arm, or any other functionally compatible design which can provide brace support. Additional shapes may be contemplated to comfortably accommodate a user with a disability or provides a sitting surface in addition to structural support.

When either railing sides 110 is rotated or pivoted, support arm 114 optimally can rotate and/or pivot in the same manner which facilitates the changes in size and shape of ladder 100 for moving and/or storing.

Support arm 114 can optionally be removably attached to the railing sides 110, allowing for further breakdown ladder 100.

FIG. 1 also illustrates at least one platform step 130 which can pivot along a second pivot axis 180. Platform step 130 provides a stepping and/or sitting surface upon which a user can elevate or lower themselves in conjunction with the balancing effect of railings sides 110.

Platform step 130 is illustrated in FIG. 1 as having a parallelogram shape, however other shapes are contemplated, by way of example only, hexagonal, triangular, octagonal, circular, or any other functionally necessary and/or compatible shape which provides a rigid, weight-bearing shape or surface which are also lightweight for ease of maneuverability and provide an adequate surface for a user to place a hand or other lifting or moving apparatus. It is further contemplated that platform step 130 have a uniform or irregular shape, as functionally necessary to operate ladder 100.

Second hinge 140 can facilitate platform step 130 pivoting along second pivot axis 180. Second hinge 140 can be any type of bearing that connects two solid objects which also allows those objects to rotate relative to each other about second pivot axis 180, which is illustrated as a fixed axis of rotation. Second hinge 180 may be constructed of a flexible material and/or of a combination of static and/or moving components.

As illustrated in FIG. 1, second hinge 140 is contemplated to be a barrel hinge, which can be a sectional barrel secured by a turnable pin or axle, where the rotational bearing force is applied to the pin or axle. However, in additional embodiments of the present invention, additional hinge configurations are also contemplated, including but not limited to pivot hinges, mortise hinges, case hinges, piano hinges, butterfly hinges, or any other functionally necessary and/or compatible hinge type.

First platform 130 can be pivotable along second pivot axis 180 in a range from 0° to 180° via second hinge 140. This range is functionally necessary to insure that ladder 100 can easily change size and shape to be storable in a small and/or narrow space.

The one or more railing sides 110 are pivotable along the first pivot axis 170 independently from the at least one platform step 130 pivotable along the second pivot axis 180.

As further illustrated in FIG. 1, when railing sides 110 or platform step 130 are in a use position 150 (shown), one of first hinge 120 or second hinge 140 is in a locked position 152. Use position 150 can be defined as ladder 100 being operable for its intended purpose, for example, as a device which assists a user with elevating and lowing themselves with a balance effect, to reach and/or locate items which are not reachable by the user without ladder 100. Locked position 152 can be defined as a finite position which can be created by first hinge 120 or second hinge 140 inherently as a functionality of hinge 120,140, or which can be created externally with additional elements of ladder 100 (not shown), such as, stoppers or other easy to use lockable mechanisms which inhibit rotational and/or pivotal movement when activated.

It is further contemplated in additional embodiments that when railing sides 110 and platform step 130 are in use position 150, the at least one first hinge 120 and the at least one second hinge 140 are in locked position 152.

It is further contemplated, but not shown in FIG. 1, that when railing sides 110 or platform step 130 are in a non-use position, one of first hinge 120 or second hinge 140 are in an open position allowing pivoting motion along first pivot axis 170 and second pivot axis 180. A non-use position can be defined as any position which is not use position 150. Open position can be defined as any position that is not locked position 152.

Each element of the foldable platform ladder 100 can be manufactured from any combination of metals, metallic composites, plastics and plastic composites.

FIG. 2 illustrates one exemplary embodiment of foldable platform step ladder 200 which includes one or more railing sides 210, at least one first hinge 220, at least one platform step 230 and at least one second hinge 240. FIG. 2 additionally illustrates one of platform step 230 in a folding position 258.

Railing sides 210 can pivot along a first pivot axis 270. Railing sides 210, as illustrated, provide the structural support element for foldable platform step ladder 200. It is contemplated that railing sides 210 provide a balance element for a user of ladder 100, as also described in reference to FIG. 1.

Railing sides 210 are illustrated in FIG. 2 as having a generally parallelogram shape, however other shapes are contemplated, by way of example only, hexagonal, triangular, octagonal, circular, or any other functionally necessary and/or compatible shape which provides a rigid, weight-bearing shape or frame which can also provide easily accessible locations for a user to place a hand or other lifting or moving apparatus. It is further contemplated that railing sides 210 have the same, similar or different shapes, as functionally necessary to operate ladder 200.

First hinge 220 can facilitate railing sides 210 pivoting along first pivot axis 270. First hinge 220 can be any type of bearing that connects two solid objects which also allows those objects to rotate relative to each other about first pivot axis 270, which is illustrated as a fixed axis of rotation. First hinge 220 may be constructed of a flexible material and/or of a combination of static and/or moving components.

As illustrated in FIG. 2, first hinge 220 is contemplated to be a barrel hinge, which can be a sectional barrel secured by a turnable pin or axle, where the rotational bearing force is applied to the pin or axle. However, in additional embodiments of the present invention, additional hinge configurations are also contemplated, including but not limited to pivot hinges, mortise hinges, case hinges, piano hinges, butterfly hinges, or any other functionally necessary and/or compatible hinge type.

Railing sides 210 are pivotable along first pivot axis 270 in a range from 0° to 360° via first hinge 220. This range is functionally necessary to insure that ladder 200 can easily change size and shape to be storable in a small and/or narrow space, also as described above.

Additional embodiments further contemplate that railing sides 210 can be pivotable along first pivot axis 270 independently from one another.

As also illustrated in FIG. 2, support arm 214 can connect railing sides 210 and can also be pivotable along first pivot axis 270 via the at least one first hinge 220. Support arm 214 provides additional structural support by providing a brace point for railing sides 210. Support arm 214 is illustrated in FIG. 2 as a linear component, however, in additional embodiments support arm 214 is contemplated to have any desired shape which can also provide the support function, for example, a curved or arced arm, or any other functionally compatible design which can provide brace support. Additional shapes may be contemplated to comfortably accommodate a user with a disability or provides a sitting surface in addition to structural support.

When either railing sides 210 is rotated or pivoted, support arm 214 optimally can rotate and/or pivot in the same manner which facilitates the changes in size and shape of ladder 200 for moving and/or storing, as also described above.

Support arm 214 can optionally be removably attached to the railing sides 210, allowing for further breakdown ladder 200.

FIG. 2 also illustrates at least one platform step 230 which can pivot along a second pivot axis 280. Platform step 230 provides a stepping and/or sitting surface upon which a user can elevate or lower themselves in conjunction with the balancing effect of railings sides 210.

Platform step 230 is illustrated in FIG. 2 as having a parallelogram shape, however other shapes are contemplated, by way of example only, hexagonal, triangular, octagonal, circular, or any other functionally necessary and/or compatible shape which provides a rigid, weight-bearing shape or surface which are also lightweight for ease of maneuverability and provide an adequate surface for a user to place a hand or other lifting or moving apparatus. It is further contemplated that platform step 230 have a uniform or irregular shape, as functionally necessary to operate ladder 200.

Second hinge 240 can facilitate platform step 230 pivoting along second pivot axis 280. Second hinge 240 can be any type of bearing that connects two solid objects which also allows those objects to rotate relative to each other about second pivot axis 280, which is illustrated as a fixed axis of rotation. Second hinge 280 may be constructed of a flexible material and/or of a combination of static and/or moving components.

As illustrated in FIG. 2, second hinge 240 is contemplated to be a barrel hinge, which can be a sectional barrel secured by a turnable pin or axle, where the rotational bearing force is applied to the pin or axle. However, in additional embodiments of the present invention, additional hinge configurations are also contemplated, including but not limited to pivot hinges, mortise hinges, case hinges, piano hinges, butterfly hinges, or any other functionally necessary and/or compatible hinge type.

First platform 230 can be pivotable along second pivot axis 280 in a range from 0° to 180° via second hinge 240. This range is functionally necessary to insure that ladder 100 can easily change size and shape to be storable in a small and/or narrow space.

The one or more railing sides 210 are pivotable along the first pivot axis 270 independently from the at least one platform step 230 pivotable along the second pivot axis 280.

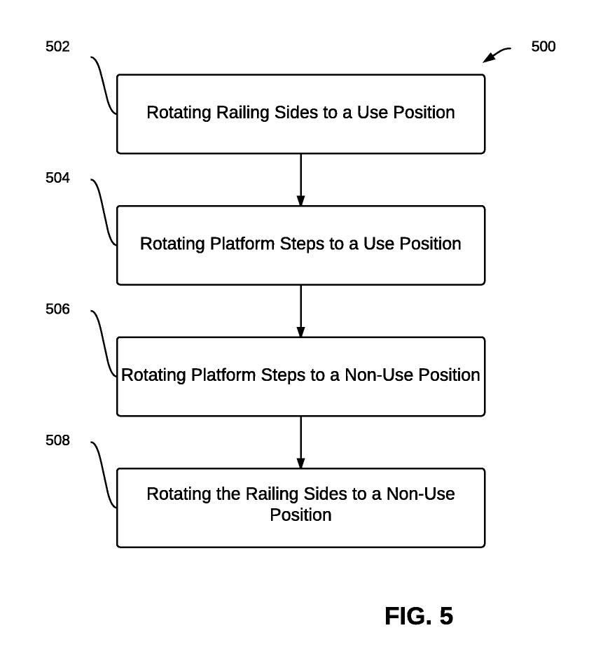

As is further illustrated in FIG. 2, one of platform step 230 is illustrated as in folding position 258. Folding position 258 can be defined as any position which is not a use position (not shown) and not a locked position (not shown). As illustrated, folding position 258 is shown as 180° or 0°, respectively, depending on perspective and directional location along second pivot axis 280. Folding position 258 is an open position which a user should place platform step 230, as discussed more fully below with reference to FIG. 5, when employing ladder 200 to non-use or broken down position for moving and/or storing.

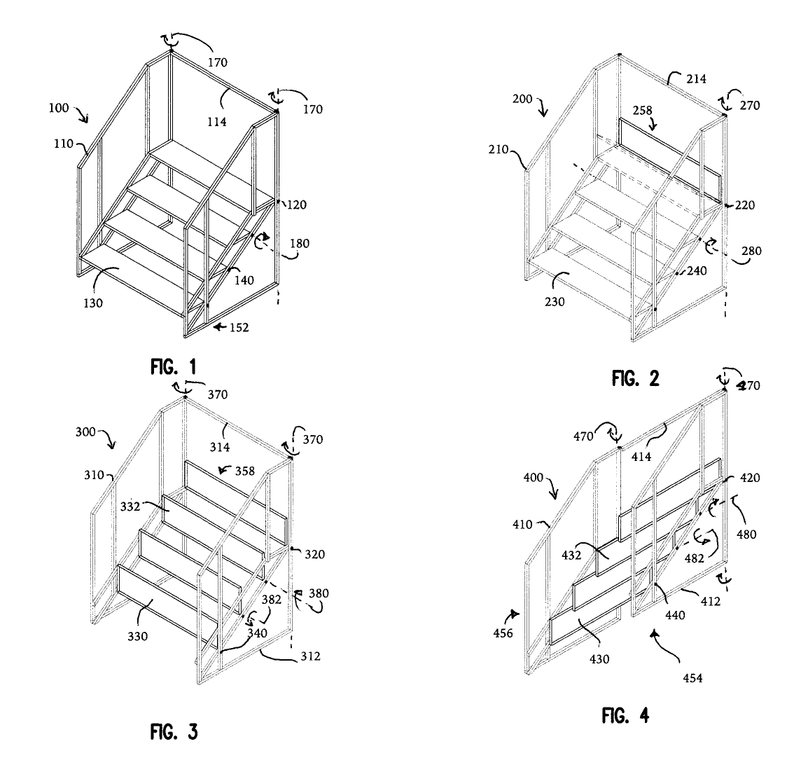

It is further contemplated, but not shown in FIG. 2, that when both railing sides 210 and platform step 230 are in a non-use position, one of first hinge 220 or second hinge 240 are in an open position allowing pivoting motion along first pivot axis 270 and second pivot axis 280. A non-use position can be defined as any position which is not use position (as defined above with reference to FIG. 1). Open position can be defined as any position that is not locked position (as defined above with reference to FIG. 1. An illustrative embodiment illustrating non-use position is defined below, in reference to FIG. 4.

FIG. 3 illustrates an exemplary embodiment of the present invention, including a folding platform ladder 300 comprising at least one first railing side 310, at least one second railing side 312, at least one first hinge 320, at least one first platform step 330, and at least one second hinge 340, where first platform step 330 and optional (but shown) second platform step 332 are in folding position 358.

First railing side 310 can be pivotable along a first pivot axis 370. First railing side 310, as illustrated, provides structural support for foldable platform step ladder 300. It is contemplated that first railing side 310 provide a balance element for a user of ladder 300.

First hinge 320 can facilitate first railing side 310 pivoting along first pivot axis 370. First hinge 320 can be any type of bearing that connects two solid objects which also allows those objects to rotate relative to each other about first pivot axis 370, which is illustrated as a fixed axis of rotation. First hinge 320 may be constructed of a flexible material and/or of a combination of static and/or moving components. First hinge 320 can have any functionally compatible configuration and/or shape, as more fully described with reference to FIGS. 1-2.

Second railing side 312 can be pivotable along first pivot axis 370. Second railing side 312, as illustrated, additionally provides structural support for foldable platform step ladder 300. It is contemplated that second railing side 312 provides an additional balance element for a user of ladder 300. It is further contemplated that second railing side 312 can be pivotable along a pivot axis (not shown) which is not first pivot axis 370.

As illustrated in FIG. 3, first railing side 310 and second railing side 312 can be pivotable along the first pivot axis 370, in conjunction with one another or independently from one another.

First hinge 320 can also facilitate second railing side 312 pivoting along first pivot axis 370. However, additional embodiments are further contemplated where a third hinge (not shown) is also contemplated, for example, for embodiments where second railing side 312 is pivotable along a pivot axis (not shown) which is not first pivot axis 370. Third hinge can have any functionally compatible configuration and/or shape, as more fully described with reference to FIGS. 1-2.

FIG. 3 also illustrates support arm 314 which can connect first railing side 310 and second railing 312. Support arm 314 can pivot along first pivot axis 370 via at least one first hinge 320. Support arm 314 provides additional structural support by providing a brace point for railing sides 310. Support arm 314 is illustrated in FIG. 3 as a linear component, however, in additional embodiments support arm 314 is contemplated to have any desired shape which can also provide the support function, for example, a curved or arced arm, or any other functionally compatible design which can provide brace support. Additional shapes may be contemplated to comfortably accommodate a user with a disability or provides a sitting surface in addition to structural support.

When first railing side 310 and/or second railing side 312 is rotated or pivoted, support arm 314 can rotate and/or pivot in the same manner which facilitates the changes in size and shape of ladder 300 for moving and/or storing, as also described above.

Additional embodiments are contemplated, for example, where support arm 314 can pivot along first pivot axis 370 via first hinge 320 and also pivots along another pivot axis (not shown) via at least one fourth hinge (not shown) that can centrally located along the body of support arm 370. For these embodiments, by way of example, rotation and/or pivoting motion of support arm 314 can begin upon rotational and/or pivot motion of either of first railing side 310 or second railing side 312.

Support arm 314 can optionally be removably attached to first railing side 310 and/or second railing side 312, allowing for further breakdown ladder 300.

First platform step 330 can be pivotable along second pivot axis 380. First platform step 330 provides a stepping and/or sitting surface upon which a user can elevate or lower themselves in conjunction with the balancing effect of first railing side 310 and/or second railing side 312.

First platform step 330 is illustrated in FIG. 3 as having a parallelogram shape, however other shapes are contemplated, by way of example only, hexagonal, triangular, octagonal, circular, or any other functionally necessary and/or compatible shape which provides a rigid, weight-bearing shape or surface which are also lightweight for ease of maneuverability and provide an adequate surface for a user to place a hand or other lifting or moving apparatus. It is further contemplated that first platform step 330 have a uniform or irregular shape, as functionally necessary to operate ladder 300.

Second hinge 340 can facilitate first platform step 330 pivoting along second pivot axis 380. Second hinge 340 can be any type of bearing that connects two solid objects which also allows those objects to rotate relative to each other about second pivot axis 380, which is illustrated as a fixed axis of rotation. Second hinge 340 may be constructed of a flexible material and/or of a combination of static and/or moving components. Second hinge 340 can have any functionally compatible configuration and/or shape, as more fully described with reference to FIGS. 1-2.

As is further illustrated in FIG. 3, first platform step(s) 330 is (are) illustrated as in folding position 358. Folding position 358 can be defined as any position which is not a use position (not shown) and not a locked position (not shown). As illustrated, folding position 358 is shown as 180° or 0°, respectively, depending on perspective and directional location along second pivot axis 380. Folding position 358 is an open position which a user should place first platform step 330, as discussed more fully below with reference to FIG. 5, when employing ladder 300 to non-use or broken down position for moving and/or storing.

It is further contemplated, but not shown in FIG. 3, that when both first railing side 310, second railing side 312 and first platform step 330 are in a non-use position, one of first hinge 320 or second hinge 340 are in an open position allowing pivoting motion along first pivot axis 370 and second pivot axis 380. As is illustrated in FIG. 3, platform step 330 is in a non-use position, as the folding position does not allow for platform step 330 to have the functionality of providing a step and/or seat. A non-use position can be defined as any position which is not use position (as defined above with reference to FIG. 1). Open position can be defined as any position that is not locked position (as defined above with reference to FIG. 1. An illustrative embodiment illustrating a full non-use position for folding platform ladder 300 is defined below, in reference to FIG. 4.

As is further illustrated in FIG. 3, one of first platform step 330 and optional second platform step 332 are illustrated as in folding position 358. Folding position 358 can be defined as any position which is not a use position (not shown) and not a locked position (not shown), both defined above in reference to FIG. 1. As illustrated, folding position 358 is shown as 180° or 0°, respectively, depending on perspective and directional location along second pivot axis 380. Folding position 358 is an open position which a user should place first platform step 330 and second platform step 332, as discussed more fully below with reference to FIG. 5, when employing ladder 300 to non-use or broken down position for moving and/or storing.

Second platform step 332 can be pivotable along second pivot axis 380 or optionally third pivot axis 382 via an at least one third hinge 342. Second platform step 332 can have the same, similar or different configuration as first platform step 330, as described above.

First platform step 330 and second platform step 332 can be pivotable along third pivot axis 382 in conjunction with one another or independently from one another.

FIG. 4 illustrates an additional exemplary embodiment of the present invention, a folding platform ladder 400 comprising at least one first railing side 410, at least one second railing side 412, at least one first hinge 420, at least one first platform step 430, and at least one second hinge 440, where first side railing 410, second side railing 412, first platform step 430 and optional (but shown) second platform step 432 are in a non-use position 454 and unlocked position 456.

First railing side 410 can be pivotable along a first pivot axis 470. First railing side 410, as illustrated, provides structural support for foldable platform step ladder 400. It is contemplated that first railing side 410 provide a balance element for a user of ladder 400.

First hinge 420 can facilitate first railing side 410 pivoting along first pivot axis 470. First hinge 420 can be any type of bearing that connects two solid objects which also allows those objects to rotate relative to each other about first pivot axis 470, which is illustrated as a fixed axis of rotation. First hinge 420 may be constructed of a flexible material and/or of a combination of static and/or moving components. First hinge 420 can have any functionally compatible configuration and/or shape, as more fully described with reference to FIGS. 1-2.

Second railing side 412 can be pivotable along first pivot axis 470. Second railing side 412, as illustrated, additionally provides structural support for foldable platform step ladder 400. It is contemplated that second railing side 412 provides an additional balance element for a user of ladder 400. It is further contemplated that second railing side 412 can be pivotable along a pivot axis (not shown) which is not first pivot axis 470.

As illustrated in FIG. 4, first railing side 410 and second railing side 412 can be pivotable along the first pivot axis 470, in conjunction with one another or independently from one another.

First hinge 420 can also facilitate second railing side 412 pivoting along first pivot axis 470. However, additional embodiments are further contemplated where a third hinge (not shown) is also contemplated, for example, for embodiments where second railing side 412 is pivotable along a pivot axis (not shown) which is not first pivot axis 470. Third hinge can have any functionally compatible configuration and/or shape, as more fully described with reference to FIGS. 1-2.

FIG. 4 also illustrates support arm 414 which can connect first railing side 410 and second railing 412. Support arm 414 can pivot along first pivot axis 470 via at least one first hinge 420. Support arm 414 provides additional structural support by providing a brace point for railing sides 410. Support arm 414 is illustrated in FIG. 4 as a linear component, however, in additional embodiments support arm 414 is contemplated to have any desired shape which can also provide the support function, for example, a curved or arced arm, or any other functionally compatible design which can provide brace support. Additional shapes may be contemplated to comfortably accommodate a user with a disability or provides a sitting surface in addition to structural support.

When first railing side 410 and/or second railing side 412 is rotated or pivoted, support arm 414 can rotate and/or pivot in the same manner which facilitates the changes in size and shape of ladder 400 for moving and/or storing, as also described above.

Additional embodiments are contemplated, for example, where support arm 414 can pivot along first pivot axis 470 via first hinge 420 and also pivots along another pivot axis (not shown) via at least one fourth hinge (not shown) that can centrally located along the body of support arm 470. For these embodiments, by way of example, rotation and/or pivoting motion of support arm 414 can begin upon rotational and/or pivot motion of either of first railing side 410 or second railing side 412.

Support arm 414 can optionally be removably attached to first railing side 410 and/or second railing side 412, allowing for further breakdown ladder 400.

First platform step 430 can be pivotable along second pivot axis 480. First platform step 430 provides a stepping and/or sitting surface upon which a user can elevate or lower themselves in conjunction with the balancing effect of first railing side 410 and/or second railing side 412.

First platform step 430 is illustrated in FIG. 4 as having a parallelogram shape, however other shapes are contemplated, by way of example only, hexagonal, triangular, octagonal, circular, or any other functionally necessary and/or compatible shape which provides a rigid, weight-bearing shape or surface which are also lightweight for ease of maneuverability and provide an adequate surface for a user to place a hand or other lifting or moving apparatus. It is further contemplated that first platform step 430 have a uniform or irregular shape, as functionally necessary to operate ladder 400.

Second hinge 440 can facilitate first platform step 430 pivoting along second pivot axis 480. Second hinge 440 can be any type of bearing that connects two solid objects which also allows those objects to rotate relative to each other about second pivot axis 480, which is illustrated as a fixed axis of rotation. Second hinge 440 may be constructed of a flexible material and/or of a combination of static and/or moving components. Second hinge 440 can have any functionally compatible configuration and/or shape, as more fully described with reference to FIGS. 1-2.

As is illustrated in FIG. 4, first railing side 410 and second railing side 412, are illustrated as in a folding position. Folding position 458 can be defined as any position which is not a use position (not shown) and not a locked position (not shown). As illustrated, folding position 458 for first railing side 410 and second railing side 412 is shown as 360° or 0°, respectively, depending on perspective and directional location along first pivot axis 470. Folding position 458 is an open or non-use position 454, unlocked position 456, which a user should place first railing side 410 and second railing side 412 when employing ladder 400 to non-use or broken down position for moving and/or storing.

As is further illustrated in FIG. 4, first platform step(s) 430 is (are) illustrated as in folding position 458. As illustrated, folding position 458 is shown as 180° or 0°, respectively, depending on perspective and directional location along second pivot axis 480. Folding position 458 is an open or non-use position 454 which a user should place first platform step 430 when employing ladder 400 to non-use or broken down position for moving and/or storing.

As depicted, when first railing side 410, second railing side 412, support arm 414 and first platform step 430 are in non-use position 454, one of first hinge 420 or second hinge 440 are in an unlocked position 456 allowing pivoting motion along first pivot axis 370 and second pivot axis 380. As is illustrated in FIG. 4, first railing side 410, second railing side 412, and support 414 are in non-use position 454, which does not allow for railing sides 410, 412 and support arm 414 to have the functionality to provide structural support and/or balancing.

As is also depicted in FIG. 4, first platform step 430 and optional second platforms step 432 is also in non-use position 454, as non-use position 454 does not allow for first platform step 430 or second platform step 432 to have the functionality of providing a step and/or seat.

Second platform step 432 can be pivotable along second pivot axis 480 or optionally third pivot axis 482 via an at least one third hinge 442. Second platform step 432 can have the same, similar or different configuration as first platform step 430, as described above.

First platform step 430 and second platform step 432 can be pivotable along third pivot axis 382 in conjunction with one another or independently from one another.

FIG. 5 illustrates an exemplary method of employing a foldable platform ladder according to the inventive concept.

The method 500 of employing a foldable platform ladder begins at 502 by a user rotating one or more railing sides to a use position. Rotating to a use position by a user occurs by pivoting the one or more railing sides via at least one first hinge along a first pivot axis and locking the at least one first hinge.

Next at 504, a user continues by rotating one or more platform steps to a use position. Rotating the one or more platform steps to a user position occurs by pivoting the one or more platform steps via at least one second hinge along a second pivot axis and locking the at least one second hinge. At 504, the ladder is in a “set-up” or use position. No parts of the ladder should be movable in this position, however, if a user does not properly lock one or more of the hinges as described, either the sides and/or the platforms may rotate and/or pivot independently of any action by the user.

The method continues at 506 by a user rotating the one or more platform steps to a non-use position by unlocking the at least one second hinge and pivoting the one or more platform steps along the second pivot axis.

The method ends at 508, by a user rotating the one or more railing sides to a non-use position by unlocking the first hinge and pivoting said at least first railing side along the first pivot axis. At 508, the ladder is in a “folded-up” or non-use position. In this position, the parts of the ladder are freely movable, and/or optionally lockable.

Additional methods, aspects and elements of the present inventive concept are contemplated in use in conjunction with individually or in any combination thereof which will create a reasonably function device to be of use as a grabbing apparatus to removably connect to a docking location. Methods of use are also contemplated using all optional aspects and embodiments as described above, individually or in combination thereof.

It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement and components shown and described above, but may be susceptible to numerous variations within the scope of the invention.

Moreover, particular exemplary features described herein in conjunction with specific embodiments and/or aspects of the present invention are to be construed as applicable to any embodiment described within, enabled thereby, or apparent wherefrom. Thus, the specification and drawings are to be regarded in a broad, illustrative, and enabling sense, rather than a restrictive one.

Further, it will be understood that the above description of the embodiments of the present invention are susceptible to various modifications, changes, and adaptations, and the same are intended to be comprehended within the meaning and range of equivalents of the appended claims.

Therefore, I claim:

1. A foldable platform step ladder, comprising:
one or more railing sides which are pivotable along a first pivot axis;
at least one first hinge which facilitates said one or more railing sides pivoting along the first pivot axis;
at least one platform step which is pivotable along a second pivot axis; and
at least one second hinge which facilitates said at least one platform step pivoting along the second pivot axis;
wherein when said one or more railing sides or said at least one platform step are in an use position, one of the at least one first hinge or the at least one second hinge are in a locked position; and
wherein when said one or more railing sides or said at least one platform step are in a non-use position, one of the at least one first hinge or the at least one second hinge are in an open position allowing pivoting motion along the first pivot axis and the second pivot axis.

2. The foldable platform ladder of claim 1, wherein when said one or more railing sides and said at least one platform step are in a use position, the at least one first hinge and the at least one second hinge are in a locked position; and wherein when said one or more railing sides and said at least one platform step are in a non-use position, the at least one first hinge and the at least one second hinge are in an open position allowing pivoting motion along the first pivot axis and the second pivot axis.

3. The foldable platform ladder of claim 1, wherein the one or more railing sides are pivotable along the first pivot axis independently from the at least one platform and the one or more railing sides are pivotable along the first pivot axis independently from one another.

4. The foldable platform ladder of claim 1, wherein the one or more railing sides are pivotable along the first pivot axis in a range from 0° to 360° via the at least one first hinge.

5. The foldable platform ladder of claim 1, further comprising at least one support arm connecting the one or more railing sides which are pivotable along the first pivot axis via the at least one first hinge.

6. The foldable platform ladder of claim 1, wherein the one or more railing sides are pivotable along the first pivot axis independently from each other.

7. The foldable platform ladder of claim 1, wherein the at least one platform step is pivotable along the second pivot axis in a range from 0° to 180°.

8. The foldable platform ladder of claim 1, wherein the at least one platform step is removable.

9. The foldable platform ladder of claim 1, wherein each element of the foldable platform ladder can be manufactured from any combination of metals, metallic composites, plastics and plastic composites.

10. A foldable platform ladder comprising:
at least one first railing side which is pivotable along a first pivot axis;
at least one first hinge which facilitates said at least one first railing side pivoting along the first pivot axis;
at least one second railing side which is pivotable along a first pivot axis;
at least one second hinge which facilitates said at least one second railing side pivoting along the first pivot axis;
at least one platform step which is pivotable along a second pivot axis; and
at least one third hinge which facilitates said at least one platform step pivoting along the second pivot axis;
wherein when said at least one first railing side, at least one second railing side and said at least one platform step are in an use position, one of the at least one first hinge, the at least one second hinge and the at least one third hinge are in a locked position; and
wherein when said at least one first railing side, at least one second railing side and said at least one platform step are in a non-use position, one of the at least one first hinge, the at least one second hinge, and the at least one third hinge are in an open position allowing pivoting motion along the first pivot axis and the second pivot axis.

11. The foldable platform ladder of claim 10, further comprising
at least one second platform step pivotable along a third pivot axis via the at least one third hinge.

12. The foldable platform ladder of claim 10, wherein the at least one first railing side and the at least one second railing side are pivotable along the first pivot axis independently from the at least one first platform step and are pivotable along the first pivot axis independently from one another.

13. The foldable platform ladder of claim 11, wherein the at least one first platform step and the at least one second platform step are pivotable along the third pivot axis independently from one another.

14. The foldable platform ladder of claim 10, wherein the at least one first railing side and the at least one second railing side are pivotable along the first pivot axis in a range from 0° to 360° via the at least one first hinge.

15. The foldable platform ladder of claim 11, wherein the at least one first platform and the at least one second platform are pivotable along the third pivot axis in a range from 0° to 180°.

16. The foldable platform ladder of claim 10, wherein the at least one platform step is removable.

17. The foldable platform ladder of claim 11, wherein the at least one second platform step is removable.

18. The foldable platform ladder of claim 10, further comprising at least one support arm connecting the at least one first railing side and the at least one second railing, wherein the support arm pivots along the first pivot axis via at least one first hinge.

19. The foldable platform ladder of claim 10, further comprising at least one support arm connecting the at least one first railing side and the at least one second railing side, wherein the support arm pivots along the first pivot axis via at least one first hinge and pivots along a fourth pivot axis via at least one fourth hinge that is centrally located along the body of the support arm.

20. A method of employing a foldable platform ladder, comprising:
rotating one or more railing sides to a use position by pivoting said one or more railing sides via at least one first hinge along a first pivot axis and locking the at least one first hinge;
rotating one or more platform steps to a use position by pivoting said one or more platform steps via at least one second hinge along a second pivot axis and locking the at least one second hinge;
rotating the one or more platform steps to a non-use position by unlocking the at least one second hinge and pivoting said one or more platform steps along the second pivot axis; and
rotating the one or more railing sides to a non-use position by unlocking the first hinge and pivoting said at least first railing side along the first pivot axis.
